(19) United States
(12) Patent Application Publication
(10) Pub. No.: US 2015/0261788 A1
(43) Pub. Date: Sep. 17, 2015

(54) Generating Digital Data From Physical Media

(71) Applicant: WellAware Holdings, Inc., San Antonio, TX (US)

(72) Inventor: David Allen Sisk, San Antonio, TX (US)

(21) Appl. No.: 14/631,590

(22) Filed: Feb. 25, 2015

Related U.S. Application Data
(60) Provisional application No. 61/953,145, filed on Mar. 14, 2014.

(51) Int. Cl. G06F 17/30

(52) U.S. Cl. CPC G06F 17/30247; G06F 17/30864

(57) ABSTRACT

Implementations of the present disclosure include methods, systems, and computer-readable storage mediums for providing digital data from physical media of a site. Actions can include receiving an image file associated with a site, the image file being associated with an image that depicts a physical medium located at the site, the physical medium physically recording data associated with the site, processing the image file to provide digital data, the digital data being provided based on the data physically recorded on the physical medium, associating the digital data with the site, and storing the digital data.

### CROSS-REFERENCE TO RELATED APPLICATIONS

This application claims priority to U.S. Provisional Application Ser. No. 61/953,145, filed on Mar. 14, 2014, which is expressly incorporated herein by reference.

### BACKGROUND

Physical media can be used to record information. For example, physical media can include a chart, a graph and/or a table that are used to record information. Example information can include measurements of one or more parameters. In some examples, measurements are automatically recorded to the physical media by a recording device. In some examples, measurements are manually recorded by a human operator.

Such physical media can be located at sites, such as well-sites. In some instances, human operators periodically visit a site to collect physical media, and install new physical media for continued recording of information. In some instances, the human operator manually records information that is already recorded on physical media without removing and replacing the physical media. In some cases, the manually recorded information is the human operator's estimate and/or is an estimated average of the information actually recorded on the physical media.

### SUMMARY

Implementations of the present disclosure include computer-implemented methods generating digital data from physical media that provides information recorded at a well-site. In some implementations, actions include receiving an image file associated with a site, the image file being associated with an image that depicts a physical medium located at the site, the physical medium physically recording data associated with the site, processing the image file to provide digital data, the digital data being provided based on the data physically recorded on the physical medium, associating the digital data with the site, and storing the digital data. Other implementations include corresponding systems, apparatus, and computer programs, configured to perform the actions of the methods, encoded on computer storage devices.

These and other implementations can each optionally include one or more of the following features: the physical medium includes a run-ticket; the data physically recorded on the physical medium includes opening gauge, closing gauge, oil gravity, oil temperature, tank temperature, bottom sediment and water (BS&W), time, date, and/or an identifier associated with personnel; the physical medium comprises a chart; the chart includes one of a strip chart, a circular chart, and a roll-chart; the data physically recorded on the physical medium is manually recorded; the data physically recorded on the physical medium is automatically recorded; processing the image file includes processing the image file based on a parser, the parser providing instructions and/or rules for processing the image to provide the digital data; the parser is selected from a plurality of parsers based on a type of the physical medium; the image is processed to determine the type of the physical medium; the image file includes metadata that indicates the type of physical medium; the parser is specific to the type of the physical medium; actions further include transmitting the digital data to a computing device, the computing device displaying a representation of the digital; the representation includes a chart, a graph, or a table; the image file is received at a back-end system from a computing device, the back-end system processing the image filed; and the site includes a well-site.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system in accordance with implementations of the present disclosure.

FIG. 2 depicts an example portion of a play network.

FIG. 3 depicts a representation of an example well-site.

FIG. 4 depicts an example screen-shot in accordance with implementations of the present disclosure.

FIG. 5 depicts another example screen-shot in accordance with implementations of the present disclosure.

FIG. 6 depicts an example processes that can be executed in accordance with implementations of the present disclosure.

Like reference symbols in the various drawings indicate like elements.

### DETAILED DESCRIPTION

Implementations of the present disclosure are generally directed to generating digital data from physical media that provides information recorded at a well-site. More specifically, implementations of the present disclosure process one or more images of physical media to generate digital data corresponding to information recorded on the physical media. In some examples, the physical media includes a chart that is used to record measurements of one or more parameters. In some examples, measurements are automatically recorded by a recording device. In some examples, measurements are manually recorded.

In some implementations, an operator uses a device to generate the one or more images as one or more machine-readable files, respectively. In some examples, the one or more images are provided to a back-end service that processes the images to generate the digital data. In some examples, the physical media is electronically recreated to provide one or more representations of the digital data. Example representations can include charts, graphs, tables, text and the like.

In some implementations, the one or more machine-readable files are archived in a file library. In some examples, the one or more machine-readable files are archived for use in a subsequent audit. For example, a particular well-site can be audited, which auditing can include review of content captured in the one or more machine-readable files. In some examples, an image file can be converted to another file format. For example, the image file can be converted to a portable document format (PDF) for archiving.

Implementations of the present disclosure will be discussed in further detail with reference to an example context. The example context includes oil and gas well-sites. It is appreciated, however, that implementations of the present disclosure can be realized in other appropriate contexts, e.g., a chemical plant, a fertilizer plant, tank batteries (located away from a site), above-ground appurtenances (pipelines) and/or intermediate sites. An example intermediate site can include a central delivery point that can be located between a site and a refinery, for example. Within the example context, implementations of the present disclosure are discussed in further detail with reference to an example sub-context. The example sub-context includes a production well-site. It is appreciated, however, that implementations of the present disclosure can be realized in other appropriate sub-contexts, e.g., an exploration well-site, a configuration well-site, an injection well-site, an observation well-site, and a drilling well-site.

In the example context and sub-context, well-sites can be located in natural resource plays. A natural resource play can be associated with oil and/or natural gas. In general, a natural resource play includes an extent of a petroleum-bearing formation, and/or activities associated with petroleum development in a region. An example geographical region can include southwestern Texas in the United States, and an example natural resource play includes the Eagle Ford Shale Play.

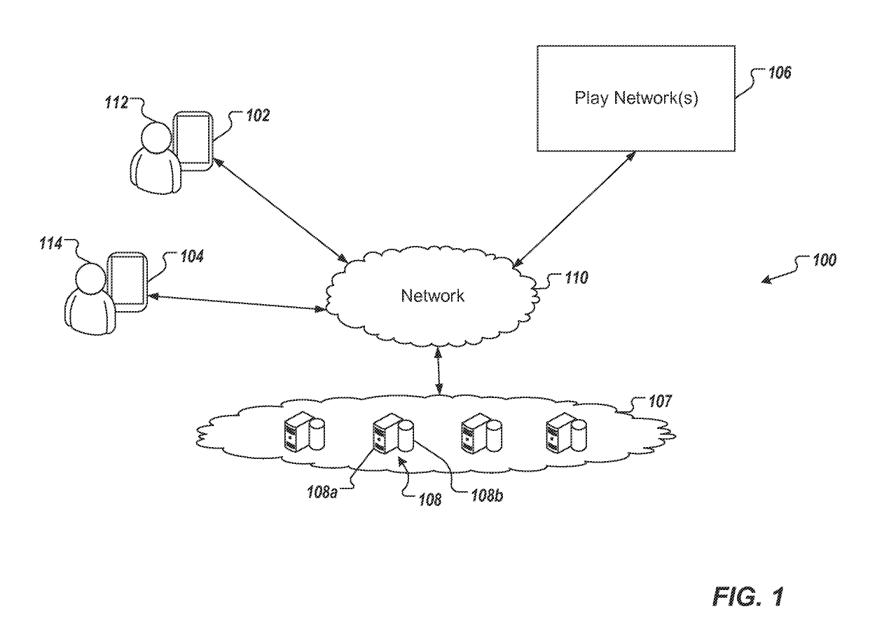

FIG. 1 depicts an example system 100 that can execute implementations of the present disclosure. The example system 100 includes one or more computing devices, such as computing devices 102, 104, one or more play networks 106, and a computing cloud 107 that includes one or more computing systems 108. The example system 100 further includes a network 110. The network 110 can include a large computer network, such as a local area network (LAN), wide area network (WAN), the Internet, a cellular network, a satellite network, a mesh network, e.g., 900 Mhz, one or more wireless access points, or a combination thereof connecting any number of mobile clients, fixed clients, and servers. In some examples, the network 110 can be referred to as an upper-level network.

The computing devices 102, 104 are associated with respective users 112, 114. In some examples, the computing devices 102, 104 can each include various forms of a processing device including, but not limited to, a desktop computer, a laptop computer, a tablet computer, a wearable computer, a handheld computer, a personal digital assistant (PDA), a cellular telephone, a network appliance, a smart phone, an enhanced general packet radio service (EGPRS) mobile phone, or an appropriate combination of any two or more of these example data processing devices or other data processing devices. The computing systems 108 can each include a computing device 108a and computer-readable memory provided as a persistent storage device 108b, and can represent various forms of server systems including, but not limited to a web server, an application server, a proxy server, a network server, or a server farm.

In some implementations, and as discussed in further detail herein, site data (e.g., oil data and/or gas data) can be communicated from one or more of the play networks 106 to the computing systems 108 over the network 110. In some examples, each play network 106 can be provided as a regional network. For example, a play network can be associated with one or more plays within a geographical region. In some examples, each play network 106 includes one or more sub-networks. As discussed in further detail herein, example sub-networks can include a low power data sub-network, e.g., a low power machine-to-machine data network (also referred to as a smart data network and/or an intelligent data network, one or more wireless sub-networks, and mesh sub-networks, e.g., 900 Mhz.

In some examples, the computing systems 108 store the well data and/or process the well data to provide auxiliary data. In some examples, the well data and/or the auxiliary data are communicated over the play network(s) 106 and the network 110 to the computing devices 102, 104 for display thereon. In some examples, user input to the computing devices 102, 104 can be communicated to the computing systems 108 over the network 110.

In general, monitoring of well sites can include oil well monitoring and natural gas well monitoring (e.g., pressure(s), temperature(s), flow rate(s)), compressor monitoring (e.g., pressure, temperature), flow measurement (e.g., flow rate), custody transfer, tank level monitoring, hazardous gas detection, remote shut-in, water monitoring, cathodic protection sensing, asset tracking, water monitoring, access monitoring, and valve monitoring. In some examples, monitoring can include monitoring the presence and concentration of fluids (e.g., gases, liquids). In some examples, control capabilities can be provided, such as remote valve control, remote start/stop capabilities, remote access control.

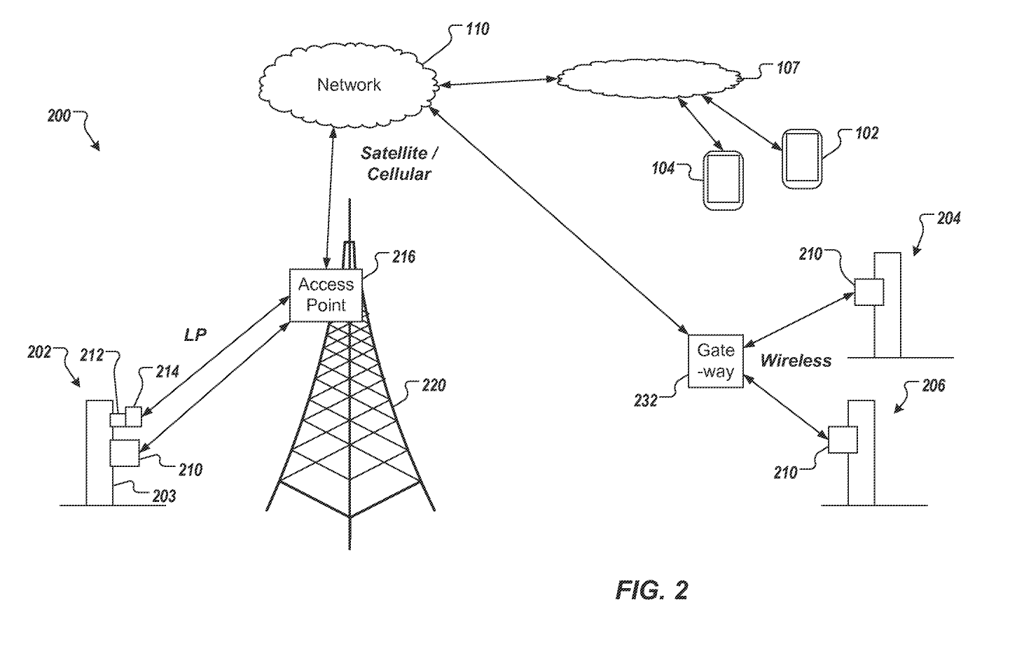

FIG. 2 depicts an example portion of an example play network 200. The example play network 200 provides low power (LP) communication, e.g., using a low power data network, and cellular and/or satellite communication for well data access and/or control. In some examples, as discussed herein, LP communication can be provided by a LP network. In the example of FIG. 2, a first well site 202, a second well site 204 and a third well site 206 are depicted. Although three well sites are depicted, it is appreciated that the example play network 200 can be associated with any appropriate number of well sites. In the example of FIG. 2, well monitoring and data access for the well site 202 is provided by the play network 200 using LP communication and cellular and/or satellite communication, and well monitoring and data access for the well sites 204, 206 is provided by the play network 200 using cellular, satellite, and/or mesh network communication.

The example of FIG. 2 corresponds to the example context and sub-context (a production well-site) discussed above. It is appreciated, however, that implementations of the present disclosure are applicable in any appropriate context. In the depicted example, the well site 202 includes a wellhead 203, a sensor system 210, a sensor system 212 and communication device 214. In some examples, the sensor system 210 includes a wireless communication device that is connected to one or more sensors, the one or more sensors monitoring parameters associated with operation of the wellhead 203. In some examples, the wireless communication device enables monitoring of discrete and analog signals directly from the connected sensors and/or other signaling devices. In some examples, the sensor system 210 can provide control functionality (e.g., valve control). Although a single sensor system 210 is depicted, it is contemplated that a well site can include any appropriate number of sensor systems 210. In some examples, the sensor system 212 includes one or more sensors that monitor parameters associated with operation of the wellhead 203. In some examples, the sensor system 212 generates data signals that are provided to the communication device 214, which can forward the data signals. Although a single sensor system 212 and communication device 214 are depicted, it is contemplated that a well site can include any appropriate number of sensor systems 212 and/or communication devices 214.

Well data and/or control commands can be provided to/from the well site 202 through an access point 216. More particularly, information can be transmitted between the access point 216, the sensor system 210, and/or the communication device 214 based on LP. In some examples, LP provides communication using a globally certified, license free spectrum (e.g., 2.4 GHz). In some examples, the access point 216 provides a radial coverage that enables the access point 216 to communicate with numerous well sites, such as the well site 202. In some examples, the access point 216 further communicates with the network 110 using cellular, satellite, mesh, point-to-point, point-to-multipoint radios, and/or terrestrial or wired communication.

In the depicted example, the access point 216 is mounted on a tower 220. In some examples, the tower 220 can include an existing telecommunications or other tower. In some examples, an existing tower can support multiple functionalities. In this manner, erection of a tower specific to one or more well sites is not required. In some examples, one or more dedicated towers could be erected.

In the depicted example, the well sites 204, 206 include respective wellheads 205, 207, and respective sensor systems 210 (discussed above). Although a single sensor system 210 is depicted for each well site 204, 206, it is contemplated that a well site can include any appropriate number of sensor systems 210. In some examples, well data and/or control commands can be provided to/from the well sites 202 through a gateway 232. More particularly, information can be transmitted between the gateway 232, and the sensor systems 210 can be wireless communication (e.g., radio frequency (RF)). In some examples, the gateway 232 further communicates with the network 110 using cellular and/or satellite communication.

In accordance with implementations of the present disclosure, well site control and/or data visualization and/or analysis functionality (e.g., hosted in the computing cloud 107 of FIGS. 1 and 2) and one or more play networks (e.g., the play networks 106, 200 of FIGS. 1 and 2) can be provided by a service provider. In some examples, the service provider provides end-to-end services for a plurality of well sites. In some examples, the service provider owns the one or more play networks and enables well site operators to use the play networks and control/visualization/monitoring functionality provided by the service provider. For example, a well site operator can operate a plurality of well sites (e.g., the well sites 202, 204, 206). The well site operator can engage the service provider for well site control/visualization/monitoring services (e.g., subscribe for services) through a play network (e.g., the play network 200). In some examples, the service provider and/or the well site operator can install appropriate sensor systems, communication devices and/or gateways (e.g., as discussed above with reference to FIG. 2). In some examples, sensor systems, communication devices and/or gateways can be provided as end-points that are unique to the well site operator.

In some implementations, the service provider can maintain one or more indices of end-points and well site operators. In some examples, the index can map data received from one or more end-points to computing devices associated with one or more well site operators. In some examples, well site operators can include internal server systems and/or computing devices that can receive well data and/or auxiliary data from the service provider. In some examples, the service provider can receive messages from well sites, the messages can include, for example, well data and an end-point identifier. In some examples, the service provider can route messages and/or auxiliary data generated by the server provider (e.g., analytical data) to the appropriate well site operator or personnel based on the end-point identifier and the index. Similarly, the service provider can route messages (e.g., control messages) from a well site operator to one or more appropriate well sites.

As introduced above, implementations of the present disclosure are directed to generating digital data from physical media that provides information recorded at a well-site. More specifically, implementations of the present disclosure process one or more images of physical media to generate digital data corresponding to information recorded on the physical media. In some examples, the physical media includes a chart that is used to record measurements of one or more parameters. In some examples, measurements are automatically recorded by a recording device. In some examples, measurements are manually recorded. In some implementations, an operator uses a device to generate the one or more images as one or more machine-readable files, respectively. In some examples, the one or more images are provided to a back-end service that processes the images to generate the digital data. In some examples, the physical media is electronically recreated to provide one or more representations of the digital data. Example representations can include charts, graphs, tables, text and the like.

In some examples, a physical medium can be used to record relevant information (data). In the example context, example physical media can include a run-ticket and a chart.

In some examples, a run-ticket can be used to record information related to removal of a fluid from a fluid reservoir. In one example, and as discussed in further detail herein, a run-ticket can be used to record information associated with the removal of oil from an oil tank. In further detail, a run-ticket is provided as a physical medium that can be used in transactions (e.g., buying, selling) associated with crude oil. For example, a run-ticket can record information reflecting a change in ownership and/or custody of an amount of oil, where a run-ticket is prepared for the receiver of the oil and the provider of the oil to record the transaction. In some examples, a run-ticket is manually filled out by on-premise personnel (e.g., a “gauger” as the representative of a receiver (purchaser) of the oil, a “pumper” as the representative of the owner (seller) of the oil). Example information recorded on a run-ticket can include opening gauge (e.g., tank level before oil is removed), closing gauge (e.g., tank level after oil is removed), oil gravity (e.g., API gravity), oil temperature, tank temperature, and bottom sediment and water (BS&W). Example information can further include time and date that the oil was removed, and the name of and/or an identifier associated with each personnel involved in removing the oil. In some examples, a run-ticket can be used as an invoice for oil purchased. Implementations of the present disclosure will be discussed in further detail herein with reference to run-tickets.

In some examples, a chart can be used to record readings provided from one or more sensors. In some examples, each sensor can be responsive to changes in a parameter (e.g., pressure, temperature, barometer) and can generate a signal in response to the parameter (e.g., an electrical signal, a physical signal (movement)). In some examples, a chart recorder can be responsive to one or more signals provided by one or more sensors, and can draw traces on a chart, the traces indicating measurements based on the sensor signals. Example chart recorders can include a strip-chart recorder, which draws traces on a strip chart, a circular chart recorder, which draws traces on a rotating disc-chart (e.g., a Barton chart), and a roll-chart recorder, which draws traces on a round roll chart. Implementations of the present disclosure will be discussed in further detail herein with reference to disc-charts.

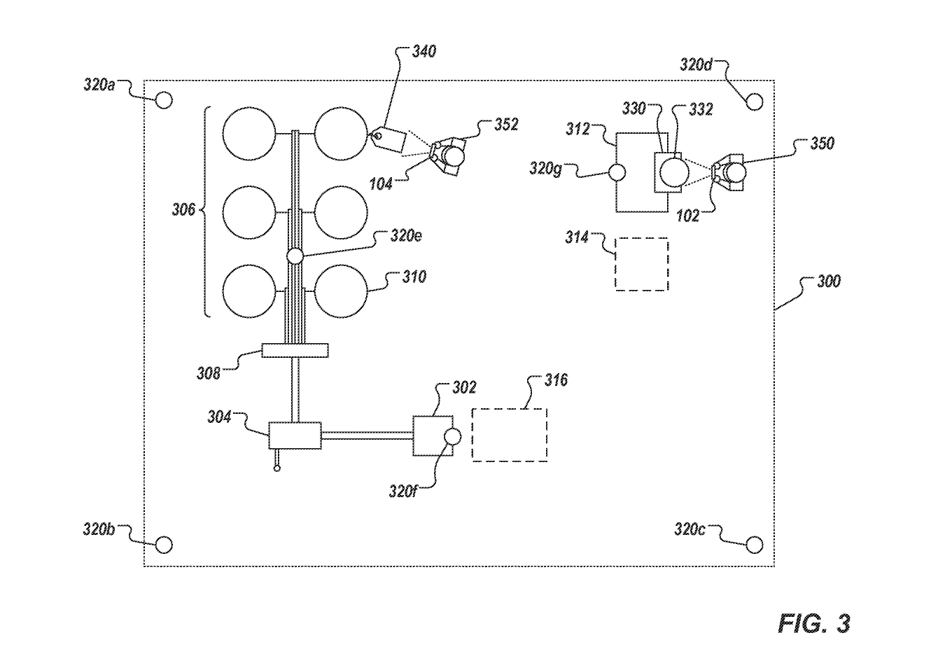

FIG. 3 depicts a representation of an example well-site 300. The example well-site 300 can include a production well-site, in accordance with the example sub-context provided above. In the depicted example, the well-site 300 includes a well-head 302, an oil and gas separator 304 and a storage tank system 306. In the depicted example, the storage tank system 306 includes a manifold 308 and a plurality of storage tanks 310. The example well-site 300 further includes a base station 312. In some examples, the well-site 300 can include a local weather station 314. In some examples, the well-site 300 can include artificial lift equipment 316 (e.g., to assist in extraction of oil and/or gas from the well).

In some examples, the well-site 300 includes one or more sensors 320a-320g. In some examples, each sensor 320a-320g can be provided as a single sensor. In some examples, each sensor 320a-320g can be provided as a cluster of sensors, e.g., a plurality of sensors. Example sensors can include fluid sensors, e.g., gas sensors, temperature sensors, and/or pressure sensors. Each sensor 320a-320g is responsive to a condition, and can generate a respective signal based thereon. In some examples, the signals can be communicated through a network, as discussed above with reference to FIG. 2. In some examples, the signals can be communicated to a chart recorder, which can draw traces on a chart in response to signals, as discussed herein.

With continued reference to FIG. 3, sensors 320a-320g can include temperature sensors and/or pressure sensors. For example, the sensors 320a-320g can be responsive to the temperature and/or pressure of a fluid. That is, the sensors 320a-320g can generate respective signals that indicate the temperature and/or pressure of a fluid. As discussed herein, data from the sensors 320a-320g can be provided to a back-end system for processing. For example, data can be provided through a play network, e.g., the play network(s) 106 of FIG. 1, to a computing cloud, e.g., the computing cloud 107. As also discussed herein, signals from one or more sensors can be provided to a chart recorder, which can draw traces on a chart in response to the signals.

In the example of FIG. 3, a chart recorder 330 is depicted, which draws traces on a chart 332. For example, the chart recorder 330 can be responsive to one or more pressure sensors, and can draw traces on the chart 332, the traces being representative of respective pressure readings from the one or more pressure sensors. The chart 332 is an example of a physical medium that provides automatically recorded measurements (recorded by the chart recorder 330).

In the example of FIG. 3, a run-ticket 340 is depicted, which records data, as discussed herein. In some examples, the run-ticket 340 is associated with a particular storage tank 310 of the storage tank system 306. The run-ticket 340 is an example of a physical medium that provides manually recorded information (e.g., information written by a person).

In accordance with implementations of the present disclosure, on-premise personnel can capture images of the physical media, which images can be processed to provide digital data based on the physical media. For example, personnel 350, 352 can each use an associated computing device 102, 104, respectively. In some examples, and as discussed above with respect to FIG. 1, the computing devices 102, 104 can include a tablet computing device, a cellular telephone, a smartphone, and a laptop computing device. In some examples, each computing device 102, 104 can include a camera associated therewith, which camera can be used to capture images. For example, the personnel 350 can use the computing device 102 to capture an image of the chart 332. As another example, the personnel 352 can use the computing device 104 to capture an image of the run-ticket 340. In some examples, each image can be saved as an image file that can be stored in memory of a respective computing device. In some implementations, one or more image files can be transmitted to a back-end system for processing. For example, image files can be transmitted to the computing cloud 107 over the network 110 of FIG. 1.

In accordance with implementations of the present disclosure, an image file can be processed to generate digital data that corresponds to data provided in a physical medium, an image of which is digitally represented in the image file. In the example case of a chart (e.g., the chart 332), the image of the chart can be processed to provide a digital version of the chart and/or to provide a graph that is based on the chart. For example, data recorded as traces in the physical chart can be extracted from the chart and can be digitally recreated as data points that can be provided in a table and/or graphed in a graph. In the example case of a run-ticket (e.g., the run-ticket 340), the image of the run-ticket can be processed to extract information from the run-ticket and to create a data record that includes at least a portion of the information, or all of the information.

In some implementations, an image can be received (e.g., an image file can be received by a back-end system) and can be processed to provide the digital data. In some examples, a type of physical media depicted in the image can be provided. For example, the image file can include metadata that indicates whether a chart is depicted in the image, or whether a run-ticket is depicted in the image. In some examples, the image file can include metadata that indicates a type of chart that is depicted in the image (e.g., a strip chart, a circular chart, a roll-chart). In some examples, the image can be processed to determine whether a chart is depicted in the image and/or a type of chart depicted in the image, or whether a run-ticket is depicted in the image. In some examples, the image can be processed based on the type of physical media that is depicted in the image.

In some implementations, the image file includes metadata that indicates parameters that are associated with the image and/or with the context that the image was captured in. Example metadata can include time data, date data, geo-location data, an identifier associated with the well-site where the image was captured, an identifier associated with a device that was used to capture the image, an identifier associated with a user that captured the image, an identifier associated with a chart recorder and/or chart depicted in the image (in the case where the image depicts a chart). It is appreciated that the image file can include any appropriate metadata that may be relevant to the context within which the image was captured. In some examples, a well-site identifier can be associated with the image. In some examples, the well-site identifier uniquely identifies the well-site. For example, a user that captured the image can manually input a well-site identifier. As another example, location data associated with the image (e.g., GPS data indicating a location, at which an image was captured) can be processed to determine the well-site identifier. For example, the location data can be input to an index of well-site locations, and can be matched to a respective well-site, the well-site identifier of the respective well-site being provided from the index.

In some implementations, a plurality of parsers can be provided, which can be used to process the image. In some examples, each parser is specific to a type of physical media. For example, a first parser can be specific to run-tickets, a second parser can be specific to strip charts, and a third parser can be specific to circular charts. In some examples, a parser is selected based on the type of physical media that is depicted in the image, and the parser is used to provide the digital data from the image. In some examples, parsers can be provided as computer-executable programs that include instructions and/or rules for processing images to provide the digital data.

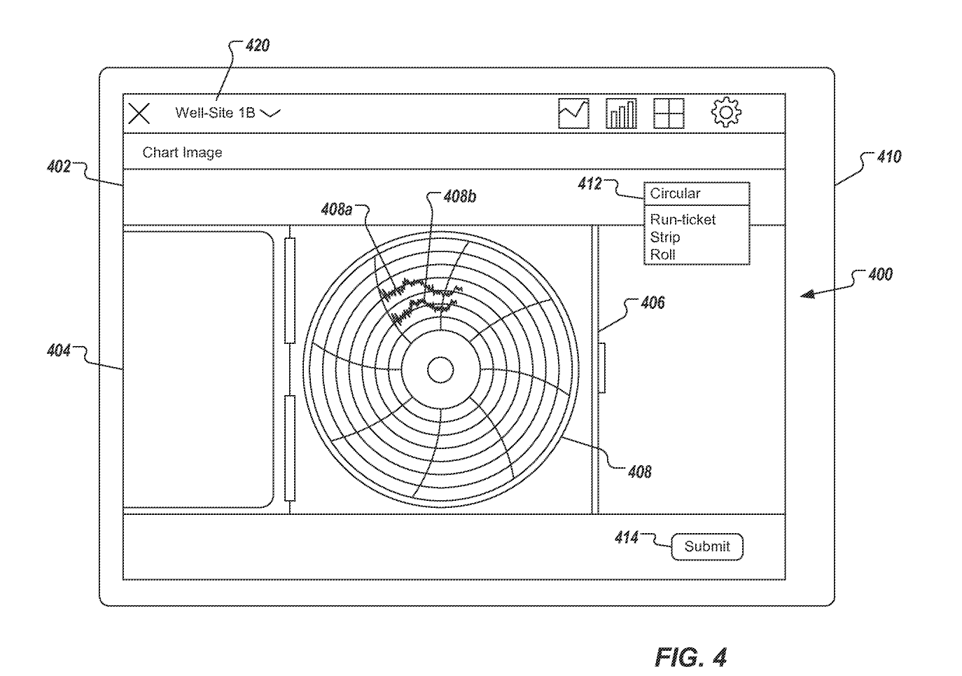

FIG. 4 depicts an example screen-shot in accordance with implementations of the present disclosure. The example screen-shot includes a GUI 400 that includes an image frame 402 having an image 404 displayed therein. In the depicted example, the image 404 depicts a chart recorder 406 (e.g., the chart recorder 330 of FIG. 1) and a chart 408 (e.g., the chart 332 of FIG. 1). In the depicted example, the chart 408 includes traces 408a, 408b. In some examples, the GUI 400 can be displayed in a display of a computing device 410 (e.g., the computing device 102, 104). In the depicted example, the GUI 400 includes an interface 412 for selecting a type of the physical media depicted in the image 404. In the depicted example, the interface 412 is provided as a drop-down menu that includes a list of types of physical media, from which a user can select a type. It is appreciated, however, that other types of interface can be provided to enable the user to select a type of the physical medium depicted in the image. In some examples, and as discussed above, the type of physical medium need not be indicated by the user, and the type can be determined automatically based on processing of the image. In the depicted example, an interface 414 is provided, and include a submit button, which the user can select to submit the image 404 for processing. For example, and in response to user-selection of the interface 414, an image file for the image 404 can be transmitted to a back-end system for processing and provision of digital data therefrom.

In some implementations, and as discussed above, the image file can include metadata that indicates parameters that are associated with the image and/or with the context that the image was captured in. For example, the device 410 can provide geo-location data, an identifier associated with the device 410 that can be provided as metadata in the image file. In some examples, the user that captured the image 404 can provide an identifier associated with the user, and an identifier associated with the chart recorder 406 and/or the chart 408 depicted in the image 404 that can be provided as metadata in the image file. For example, the GUI 400 can include user input elements (not shown) that the user can provide input. In some examples, the identifier associated with the user can be provided from credentials that the user may have previously provided to log-into software that provides the GUI 400. In the depicted example, the GUI 400 provides an indicator 420 that can indicate, which well-site the user is currently located at (e.g., Well-Site 1B). In some examples, an identifier that uniquely identifies the well-site provided in the indicator can be provided as metadata with the image file. It is appreciated that the image file can include any appropriate metadata that may be relevant to the context within which the image was captured.

In some implementations, the image file is archived in a file library. In some examples, the image file is archived for use in a subsequent audit. For example, the well-site 300 of FIG. 3 can be audited, which auditing can include review of content captured in the image file (e.g., the chart 408 of FIG. 4). In some examples, the image file can be converted to another file format. For example, the image file can be converted to a portable document format (PDF) for archiving.

In some implementations, manually entered values can be verified and/or corrected based on digital data provided from an image. For example, personnel can capture images of physical media and can also manually record values that the personnel themselves read from the physical media. For example, a person can view a chart and can estimate an average value (manual value) based on a trace provided in the chart. The average value can be provided to the back-end system (e.g., the person enters the average value into a user interface displayed on a computing device). The image of the physical media can be processed, as discussed herein, and an average value can be computed (computed value) based on the digital data determined from the image (e.g., by the back-end-system). The manual value and the computed value can be compared to determine an accuracy of the manual value, for example. In some examples, if the manual value deviates from the computed value by a threshold degree (e.g., >X %), an alert can be provided (e.g., to the person that recorded the manual value, a supervisor of the person). In this manner, improvements to manual recording of values can be achieved.

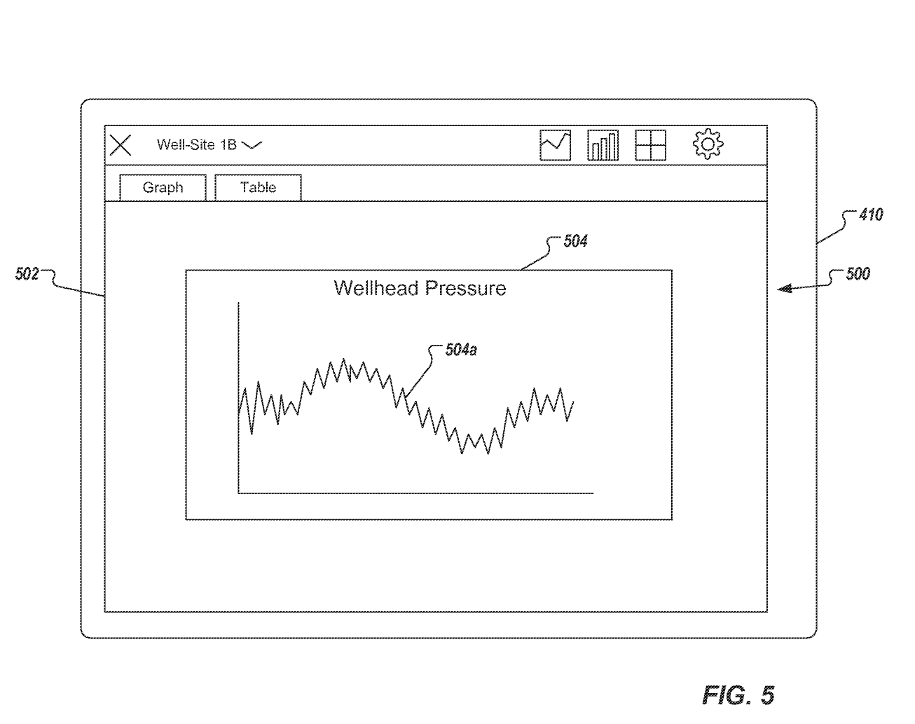

FIG. 5 depicts another example screen-shot in accordance with implementations of the present disclosure. The example screen-shot includes a GUI 500 that includes a data frame 502 having a graph 504 displayed therein. In the depicted example, the graph 504 is a digital representation of data extracted from the image 404 of the physical chart 408 (e.g., the chart recorder 330 of FIG. 1). In the depicted example, the graph 504 includes a single trace 504a. For example, the trace 504a can correspond to the trace 408a of the chart 408 depicted in the image 404. In some examples, the graph 504 can depict multiple traces (e.g., corresponding to the traces 408a, 408b of the chart 408 depicted in the image 404.

Although the example of FIG. 5 provides the digital data in a graph representation, it is appreciated that the digital data can be provided in any appropriate representation. For example, the digital data can be provided in one or more tables.

In some implementations, example physical media can include a receipt, an invoice and a work order. In some examples, well-site operators can purchase goods and/or services for operation of the well-site. In some examples, images of receipts, invoices and/or work orders can be captured, which include information relevant to the goods and/or services purchased (e.g., type, quantity, cost, date of purchase). As discussed above with respect to run-tickets and charts, images of receipts, invoices and/or work orders can be received and processed to provide digital data therefrom. In some examples, the digital data corresponds to the information captured in the images.

In some implementations, digital data provided from receipts, invoices and/or work orders can be used for auditing purposes. In some implementations, digital data provided from receipts, invoices and/or work orders can be used to provide greater granularity in cost calculations. In some examples, a cost-per-barrel value can be determined for a plurality of well-sites based on, for example, an overall operating cost determined for the plurality of well-sites and a number of barrels (e.g., of oil) produced from the plurality of well-sites. Implementations of the present disclosure enable a relatively more accurate, finer grain calculation of cost-per-barrel. For example, operating costs associated with respective well-sites can be determined, at least in part, based on digital data provided from receipts, invoices and/or work orders that are specific to individual well-sites. That is, implementations of the present disclosure enable relatively minor costs (e.g., tools purchased from a hardware store for maintenance at a particular well-site) to be attributed to specific well-sites (e.g., as opposed to a plurality of well-sites). Consequently, a relatively more accurate cost-per-barrel can be provided on a site-by-site basis. In some examples, this enables more poorly performing well-sites to be identified (e.g., for remediation).

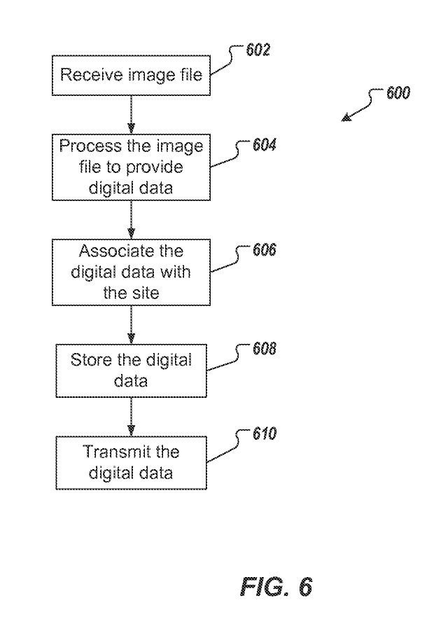

FIG. 6 depicts an example process 600 that can be executed in accordance with implementations of the present disclosure. In some examples, the example process 600 can be provided as one or more computer-executable programs executed using one or more computing devices.

An image filed is received (602). For example, a back-end system (e.g., the computing cloud 107 of FIG. 1) can receive an image file (e.g., from a computing device 102, 104 of FIG. 1). In accordance with implementations of the present disclosure, the image file is associated with a site, and includes data corresponding to an image that depicts a physical medium located at the site, the physical medium physically recording data associated with the site. The image file is processed to provide digital data (604). For example, the back-end system processes the image file to provide digital data therefrom, the digital data being provided based on data physically recorded on the physical medium. In some examples, the image file is processed based on a parser that provides instructions and/or rules for processing the image to provide the digital data. The digital data is associated with the site (606). In some examples, metadata of or provided with the image file can indicate the site that is to be associated with the digital data. For example, the metadata can provide geo-location data and/or an identifier indicating the site, at which the image was captured. The digital data is stored (608). The digital data is transmitted (610). In some examples, the digital data is transmitted to a computing device, the computing device displaying a representation of the digital.

Implementations of the subject matter and the operations described in this specification can be realized in digital electronic circuitry, or in computer software, firmware, or hardware, including the structures disclosed in this specification and their structural equivalents, or in any appropriate combinations thereof. Implementations of the subject matter described in this specification can be realized using one or more computer programs, i.e., one or more modules of computer program instructions, encoded on computer storage medium for execution by, or to control the operation of, data processing apparatus, e.g., one or more processors. In some examples, program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. In some examples, the data processing apparatus can include special purpose logic circuitry, e.g., an FPGA (field programmable gate array) or an ASIC (application specific integrated circuit). In some examples, the data processing apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a mesh network, a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for providing digital data from physical media of a site, the method being executed using one or more processors and comprising:
receiving, by the one or more processors, an image file associated with a site, the image file being associated with an image that depicts a physical medium located at the site, the physical medium physically recording data associated with the site;
processing, by the one or more processors, the image file to provide digital data, the digital data being provided based on the data physically recorded on the physical medium;
associating, by the one or more processors, the digital data with the site; and
storing, by the one or more processors, the digital data.

2. The method of claim 1, wherein the physical medium comprises a run-ticket.

3. The method of claim 2, wherein the data physically recorded on the physical medium comprises opening gauge, closing gauge, oil gravity, oil temperature, tank temperature, bottom sediment and water (BS&W), time, date, and/or an identifier associated with personnel.

4. The method of claim 1, wherein the physical medium comprises a chart.

5. The method of claim 4, wherein the chart comprises one of a strip chart, a circular chart, and a roll-chart.

6. The method of claim 1, wherein the data physically recorded on the physical medium is manually recorded.

7. The method of claim 1, wherein the data physically recorded on the physical medium is automatically recorded.

8. The method of claim 1, wherein processing the image file comprises processing the image file based on a parser, the parser providing instructions and/or rules for processing the image to provide the digital data.

9. The method of claim 8, wherein the parser is selected from a plurality of parsers based on a type of the physical medium.

10. The method of claim 9, wherein the image is processed to determine the type of the physical medium.

11. The method of claim 9, wherein the image file comprises metadata that indicates the type of physical medium.

12. The method of claim 8, wherein the parser is specific to the type of the physical medium.

13. The method of claim 1, further comprising transmitting the digital data to a computing device, the computing device displaying a representation of the digital.

14. The method of claim 13, wherein the representation comprises a chart, a graph, or a table.

15. The method of claim 1, wherein the image file is received at a back-end system from a computing device, the back-end system processing the image filed.

16. The method of claim 1, wherein the site comprises a well-site.

17. A non-transitory computer-readable storage medium coupled to one or more processors and having instructions stored thereon which, when executed by the one or more processors, cause the one or more processors to perform operations for providing digital data from physical media of a site, the operations comprising:
receiving an image file associated with a site, the image file being associated with an image that depicts a physical medium located at the site, the physical medium physically recording data associated with the site;
processing the image file to provide digital data, the digital data being provided based on the data physically recorded on the physical medium;
associating the digital data with the site; and
storing the digital data.

18. A system, comprising:
a computing device; and
a computer-readable storage device coupled to the computing device and having instructions stored thereon which, when executed by the computing device, cause the computing device to perform operations for providing digital data from physical media of a site, the operations comprising:
receiving an image file associated with a site, the image file being associated with an image that depicts a physical medium located at the site, the physical medium physically recording data associated with the site;
processing the image file to provide digital data, the digital data being provided based on the data physically recorded on the physical medium;
associating the digital data with the site; and
storing the digital data.
